(19) United States
(12) Patent Application Publication
(10) Pub. No.: US 2015/0332204 A1
(43) Pub. Date: Nov. 19, 2015

(54) Business Process Event Management System

(71) Applicant: Robert J. Brown, Boca Raton, FL (US)

(72) Inventor: Robert J. Brown, Boca Raton, FL (US)

(21) Appl. No.: 14/588,973

(22) Filed: Jan. 4, 2015

Related U.S. Application Data
(60) Provisional application No. 62/000,504, filed on May 19, 2014.

(51) Int. Cl. G06Q 10/06

(52) U.S. Cl. CPC G06Q 10/063114

(57) ABSTRACT

An automated monitoring and notification system that extracts status data input to a database by employees that relates to a work projects. The system examines the data to determine project status changes and reports both good and bad changes to management for any necessary action. The data is selectively filtered such that overall project progress, department progress, or individual employee progress can be measured. Filtered data for a project includes timing changes, cost changes, and related events that impact the project. A mobile application allows managers to obtain the project status independent of time or location.

### CROSS-REFERENCE TO RELATED APPLICATIONS

This non-provisional patent application is related to, and claims the benefit of, the provisional patent application entitled “Process Event Management System”, filed May 19, 2014, bearing U.S. Ser. No. 62/000,504 and naming Roberti. Brown, the named inventor herein, as sole inventor, the contents of which is specifically incorporated by reference herein in its entirety.

### BACKGROUND

1. Technical Field

This invention relates in general to management and control of organization processes. In particular, it relates to a system that allows organization management to have improved oversight of complex business operations that require interaction between employees, organizations and large information technology (IT) computer systems.

2. Background of the Invention

Large organizations, be they governmental, corporate (for profit or non-profit), university, military, etc., the goals of the organization typically require the completion of many large projects. In any large project, there is typically a reliance on multiple individuals to achieve the organization's goals. A major problem associated with the completion of large projects is that management often is unaware of the progress being made, and if there are any immediate problems that need to be addressed. Often, management is unaware while problems continue to worsen until they have a serious impact on completion of a particular project. Worst cases may involve a series of projects in which each project is dependent on completion of other projects. It would be desirable to have a method of keeping management aware of project progression on a dynamic online system that provides current status of one or more projects to management and which identifies and highlights problem points for each project.

In addition, different industries and organizations have widely divergent goals. As a result, there are no single systems that are suitable for monitoring and reporting on project progress on a dynamic event-to-event basis, such that management can determine if there are any problems and take immediate action before the problems escalate.

In addition to events that are not controllable by management, such as mechanical or system failures, third party adverse decisions, etc., there are also problems associated with employee behavior. Regrettably, individuals that have particular performance expectations that are based on numerical measurements will often manage the numbers to reach their performance goals. It would be desirable to have a system that could identify performance anomalies and determine their cause, be they external or internal.

By way of example, in a sales organization in the private business sector, it is important that external entities, such private and public investors, Wall Street in particular, have confidence in a company. When a company says it is going to do X and it goes forward and does X, investors see that the company has a good understanding and control of their core activities. Even when guidance and results are unfavorable, if the right expectations are set and delivered, a company is still looked upon favorably by investors. That favorable view is then reflected in value. On the other hand, when a company says it is going to do X and they do Y, even if Y is favorable, wise investors see this as a fundamental lack of control and understanding of the core business. It is not difficult to see the negative effect this can have on such a company's long-term value.

Each quarter CEO's and CFO's need to have confidence in their sales team. The SVP of Sales' job is to give confidence to the CEO and CFO by providing a realistic view of the sales pipeline that is predictable. The Sales SVP needs to have confidence in his/her sales team to roll-up all of the Opportunities in the pipeline and provide realistic and predictable numbers to the CEO and CFO. The CEO and CFO then share this information with the rest of the organization and the investor community.

Front line Sales Managers need confidence in their sellers and confidence in the information that they provide to senior management. They need to have confidence that all of the opportunities in their sales team's pipeline will add up to and exceed their planned sales objectives. Sales Managers need confidence that their time is being prioritized and used toward value added activities that will drive potential deals down the pipeline to actual purchases. Finally, the Sales Managers need confidence that they will not be surprised by any news,—good or bad. It's all about confidence.

Problems Related to the Sales Pipeline:

Front-line sales management teams and their leaders often struggle to understand and gain line-of-sight visibility into critical key changes in their open sales pipeline. Countless days of management productivity time is expended (i.e., wasted) in weekly pipeline review meetings. These meetings are to make adjustments and add ‘judgment’ to sales forecasts that are shared with other senior management such as the Finance department and the CxO's. Finance and the CxO's use this information to make important business decisions surrounding budget, headcount, financial strategy, product strategy, marketing strategy, etc. However, when it comes to the sales pipeline, the CxO's have little confidence and must rely on the “judgment” of the sales managers.

A frequent problem in many companies is that at the end of each quarter substantial amounts of dollars move and shift in and out of current quarter pipelines and often “disappear” in the last two weeks leading up to quarter close. The problem is the deals in the pipeline do not disappear; they change. Deal amounts change and sometimes move to a future quarter. Deal confidence often drops, resulting in the close date to being pushed to future quarters. Deals can change from Won or Lost or are resurrected. Deals change, but they never simply disappear. These changes impact confidence in the accuracy of the projected numbers.

Today, at a high level, many organizations use a method called sales funnel snapshots that allow senior management to see the large overall changes from day to day or week to week. Unfortunately these snapshots contain summary data only. Details on who changed what and when the change occurred is not captured. As a result, front-line management continues to rely on antiquated methods. This is a serious drawback in that medium and large sized organizations around the world spend billions of dollars on Information technology (“IT”) Departments that produce only high-level information that ignores important, and sometimes critical, details. Large and expensive internal and consultant sales productivity teams are deployed to train and mentor field sales teams on the sales process and how to focus on the right activities that drive business results. Unfortunately current IT data is often ignored or is taken with a “grain of salt.” Why? Because, regrettably, sales teams cannot be trusted to provide confident, accurate and up to date information on their activities. Until now, training and re-training the front line sellers on funnel management is a never-ending battle and it does not always work. It would be desirable to provide management with a tool that grants actionable visibility into current activities that allows both an overall view, as well as a close-up view of individual changes to, and progress of a particular project. Further, it would be desirable to provide a portable tool in mobile devices such that the entire sales management team has access to this data at any time so that they have knowledge of what is happening and which sales teams are following the sales process.

While the prior art has provided a variety of reporting systems, it has failed to provide a dynamic monitoring system that monitors project progress and identifies anomalies that adversely impact on-time completion of the project.

### SUMMARY OF THE INVENTION

This invention provides an automated monitoring and notification system that extracts status data input by employees that relates to a particulate work project. The system examines the data to determine project status changes and reports both good and bad changes to management for any necessary action. The data is selectively filtered such that overall project progress, department progress, or individual employee progress can be measured. Filtered data for a project includes timing changes, cost changes, and related events that impact the project. A mobile application allows managers to obtain the project status at any location.

### BRIEF DESCRIPTION OF THE DRAWINGS

FIG. 1 is a chart illustrating a preferred embodiment of the information flow when event data is initially entered into the BPEM System, or subsequently modified to reflect status changes.

FIG. 2 is a chart illustrating a preferred embodiment of the information flow when event data is reviewed on a periodic basis.

FIG. 3 is a chart illustrating a preferred embodiment of the information flow when event data is reviewed at a specific timeframe, such as the end of a quarterly reporting period.

FIG. 4 it is a block diagram of the BPEM system.

### DETAILED DESCRIPTION OF THE PREFERRED EMBODIMENT

Prior to a detailed discussion of the figures, a general overview of the invention will be presented that discusses the general flow of data for any type of project. Following that will be a discussion of the figures that illustrate how the system is applied to specific types of projects.

For ease of discussion, in invention will be discussed in terms of a sales organization. However, those skilled in the art will recognize that the invention can be used by any type of organizational, such as government agencies, hospitals, military, educational institutions, manufacturing, etc.

During the course of any project, it is important for a manager to be able to act quickly when the manager's team steps off the path that the team was following. The invention allows a manager to gain proactive visibility into changes to the project's pipeline, especially critical changes that will impact the project.

This invention solves the problem for millions of managers around the world who spend up to a day or more each week calling employees and/or or using antiquated manual methods trying to track key changes happening to multiple projects. These prior art methods range from whiteboards to spreadsheet, printouts, and screen shots. This is especially true in large organizations with hundreds or thousands of open projects are active at any given time. The higher up a manager is in the organizational chain-of-command, more information needs to be processed, and the harder it becomes to obtain accurate information.

There are three metrics that are critical to any project's success:

1. Identifying any timing movement up or down previously forecasted project steps. This can be a reduction in the time needed to complete the project, usually welcome news. Likewise, delays will be identified so that management can investigate the cause of the delay, and take action to remedy it.

2. Identifying any changes to the project completion date (e.g., kicking the can down the road) out of (and sometimes into) the current performance period. In most organizations, performance periods are annual quarters.

3. Identifying any changes in costs or revenue within a predetermined value and time frame. It is important for any manager to know if there are any impending changes in revenue or costs. Usually, a predetermined amount is used to generate a flag indicating a serious change to the plan. For example, a predetermined amount such as a ten percent change in cost, or a timing change such as 7 days, may be used, etc.

An advantage of the invention is that it generates a single view of all three metrics. The metrics are useful for many entities in an organization, such as senior management, non-senior management levels, and/or parties responsible for project readiness or operations, training, financial planning, and/or business intelligence.

By way of example, the following indicates how the invention might be used in practice:

1. It can be used for a daily review of “yesterday's” project activity.

2. It can be used for weekly reviews at project team meetings.

3. It can be used at beginning the of a new quarter to track which projects are progressing and which projects have been delayed from the last quarter to the current quarter.

4. It can be used mid quarter to track which projects are progressing on time and which projects have significant revenue or timing changes. Also to track projects that are nearing completion.

5. It can be used by management in 1:1 reviews with employees 1:1 coaching sessions with Individual employees for training, support or evaluations. For example, the invention allows management and employees to look back a week, a month, or a quarter.

6. It can be used at the end of a quarter to see which projects are progressing on schedule, which projects are delayed, and which projects have significant revenue changes.

7. On quarterly reviews, all three metric can be analyzed to show which projects in an area; region, or territory are progressing as expected and which need improvement or training.

8. It can be used to review performance of projects assigned to specific management personnel to see activity by one or more managers.

A further advantage of the system is that it can proactively deliver, via email/SMS/text, or any other suitable means, exception information to management at regular intervals (just In Time, Daily, Weekly, etc.) tied back to a particular project, department, or employee. In the preferred embodiment, management has the option of selecting what data is to be reported, how often it is to be reported, and how it is to be delivered. In this manner, management will be alerted as soon as a project diverges from its expected path. Furthermore, by using information that is entered into the system by the employee in the normal course of their activities, the invention allows management to be automatically updated without contacting employees for project status. As a result, there is no impact on the employees time when management seeks status updates that includes changes to project steps, changes to project completion dates, changes in expected revenue or cost, or other relevant information entered by employees.

An additional advantage provided by the invention is that it can be also implemented on portable devices in addition to office computers. A mobile app for smart phones or other devices such as tablets, notebooks, or laptops allows managers, who are often traveling, to have access to the metrics wherever and whenever they are.

In addition, managers can create their own custom good and bad news alerts and reports in the app proactivity to timely know the progress of a particular project. Armed with visibility into mid-project changes and/or status on a mobile device, managers can make real time actionable decisions and have more time to coach their employees in regard to their activities, thereby leading to better business results. In the preferred embodiment, the mobile app breaks information into two distinct categories of change over a fixed time frame: Good News and Bad News.

Good News items include positive changes to a project such as earlier than expected completion of the project or a step in the project. Other examples of Good News are when an estimated close date on a project moves from a future quarter to the current quarter or when the revenue amount from a project goes up by a predetermined amount (e.g., 10%). Knowing when Good News happens allows a sales manager to immediately take prescriptive action with the project's team.

On the other hand, Bad News items do not get better with age. In project management, examples of Bad News are when a project close date is extended or when an expected revenue amount decreases by a predetermined amount (e.g., 25%). Quickly knowing the Bad News allows a manager to react and try to put the project back on track or simply allow the manager to proactively communicate the event to senior management, depending on the situation.

The system uses a computer database in which work related events are dynamically entered into the database by responsible parties, such as sales reps or other workers. The system then provides reports to management that detail current activity, And changes the current activity which allows management to carefully monitor workload and changes to scheduling, revenue, and other activities. As data is entered into the system, It creates an up-to-date record of workflow that was previously unavailable to management on a timely basis. This not only assist management in planning activities, but also allows management to quickly be made aware of potential problems so that corrective action can be taken on a more timely basis.

News events can be filtered by project, industry, size or any other relevant criteria. A standard set of reporting templates is provided to allow a user to conveniently select the desired information.

Having discussed the system in general terms, the following figures illustrate preferred embodiments of the system as it relates to specific activities.

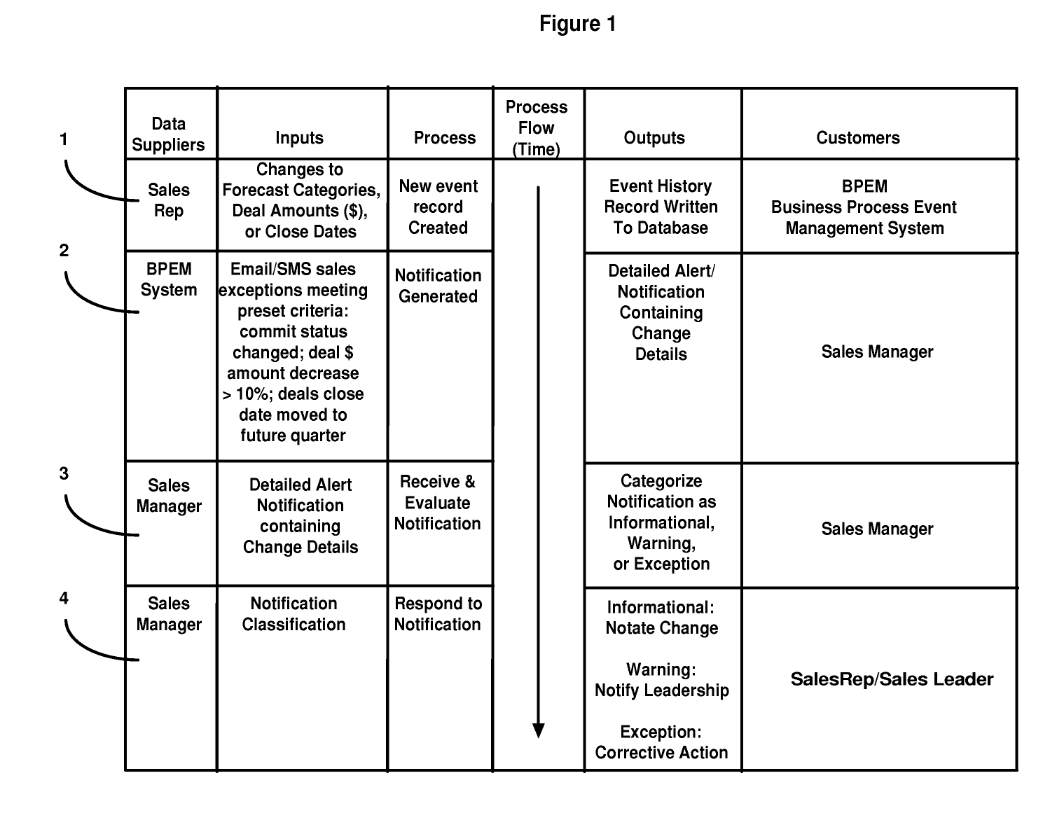

FIG. 1 is a flowchart illustrating a preferred embodiment of the daily information flow and illustrates the initial input of event information into the BPEM database. As noted above, while the system can be used to manage any type of activity or organization, a weekly review for a sales organization will be used for ease of discussion. This is the first step in the process wherein the sales rep (or other first line worker) enters status changes into the BPEM system that relate to their areas of responsibility. These changes will be related to new events, or changes to pre-existing events.

At step 1, an event record is created by a sales rep when a new work item or a change in status of an existing event occurs. For ease of discussion, the term “Sales Rep” is used to describe any employee responsible for administering a process, whether the employee is involved in sales or any other activity in an organization.

As the sales reps create new event records, they are entered into a BPEM database at step 2 and analyzed by the BPEM system to determine if the event record exceeds predetermined criteria. If the BPEM system determines that the changes reflected in the event record exceed the predetermined criteria, it generates a notification that is transmitted to management. In the preferred embodiment, the BPEM system creates a detailed notification that includes details related to the event record.

At step 3 of the process, management receives and evaluates the notification. Based on management's evaluation, a response is made by management at step 4 to correct or make other decisions related to the event.

The system records all event records and provides management of a particular group of sales reps with a report to the responsible manager, or managers, of all activity in that management's group or department. As a result, management at one or more levels is provided with the current status of all activity within their respective areas of responsibility. An advantage of the system is that event data is dynamically updated in the database so that management is not working with incorrect or outdated status information.

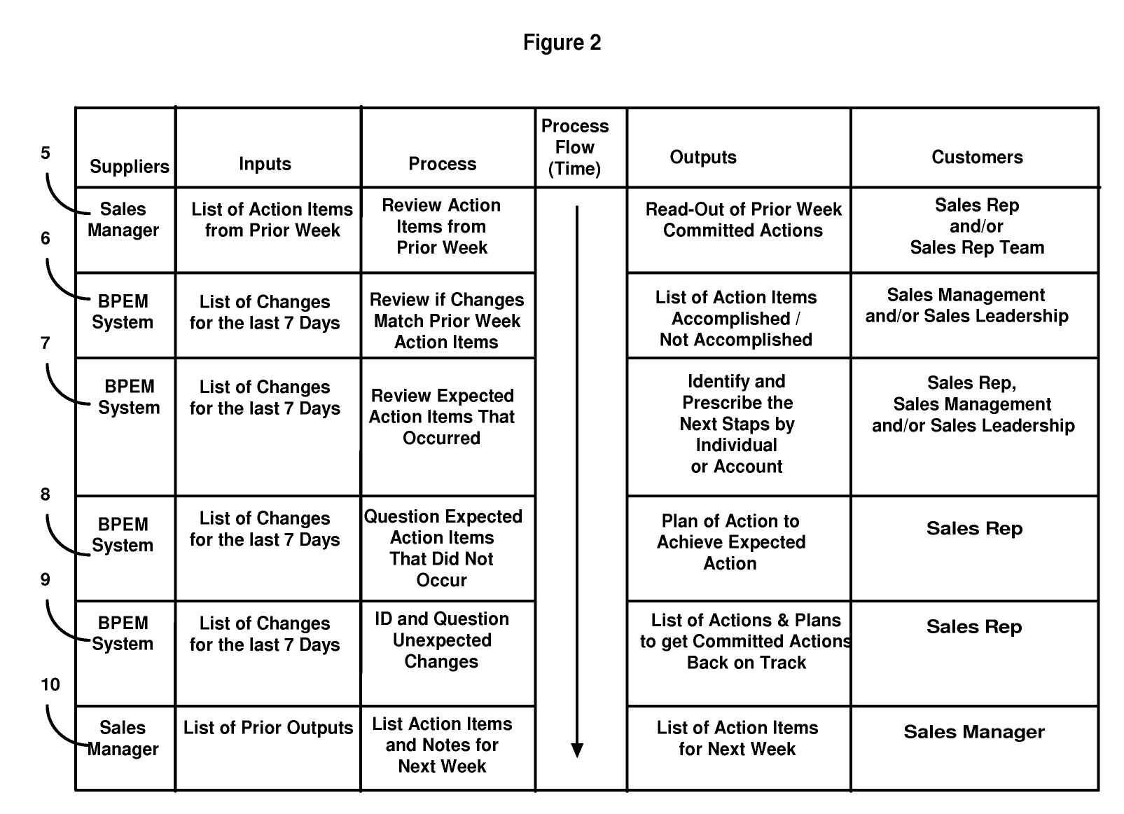

FIG. 2 is a chart illustrating a preferred embodiment of the BPEM information flow when event data is reviewed on a periodic basis. The review period can be any selected time period depending on the nature of the organization, and the project at hand.

When events are initially entered into the database, management has an expected time frame for completion. However, in any organization there are intervening events that may impact schedules. These changes are entered into the database as status changes to previously entered events. In the prior art, management was often unaware of status changes that could effect project completions until late in the game. The invention eliminates this problem by providing management with up-to-date event status information on a dynamic basis. As noted above, this example uses a weekly review of event status for discussion purposes, but in practice, management has the ability to dynamically produce status reports at management's discretion.

At step 5, the review process is initiated when the BPEM system produces a list of action items from the previous week for management. Management then reviews the action items to determine the action items that were committed to in the previous week by the sales rep or the sales rep team. This is reviewed by management with the sales reps.

At step 6, system produces a list of events related to action items for the last week, or other pre-determined review period. Management reviews this list to determine what action items were completed, or not completed. This is reviewed with sales management or sales leadership. At step 7, management decides what the next steps are for the completed action items and conveys this information to the sales reps and other management.

If action items from the last week were not completed, then, at step 8, management and the responsible sales rep make an action plan to achieve the expected results.

In addition, there are unexpected events that may occur in any organization. At step 9, the changes for the previous week are examined for unexpected changes. Management and the responsible sales rep determine the necessary actions that need to be taken to address the unexpected changes.

The final step in this part of the process, step 10, is performed by management to determine the list of action items that are planned for the next week.

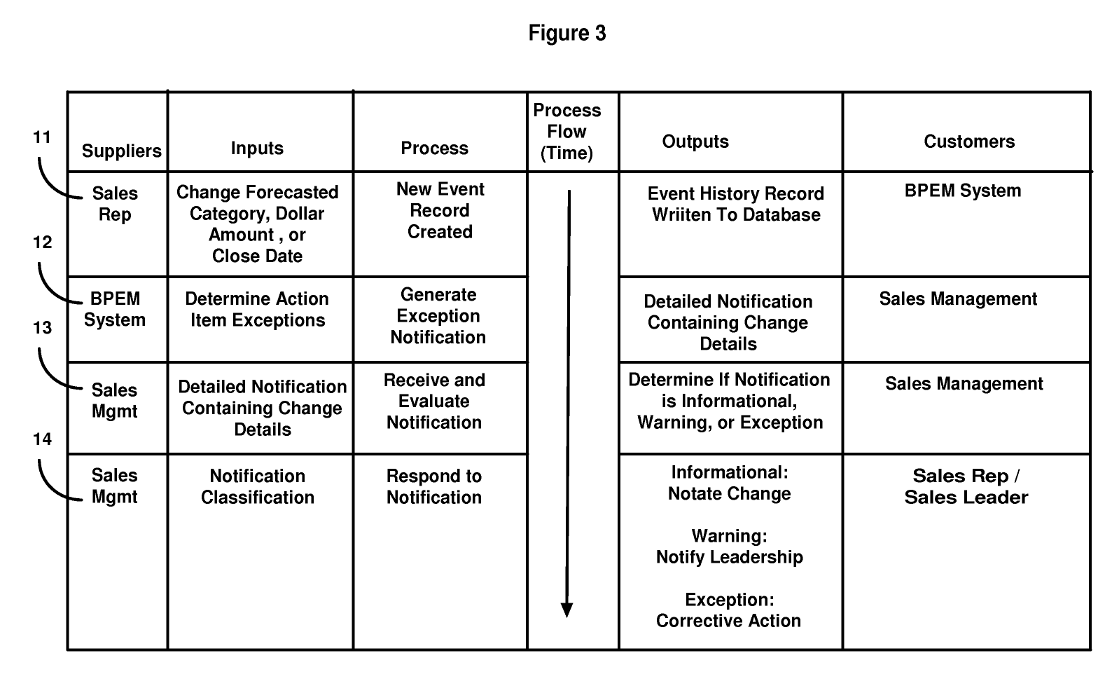

The chart in FIG. 3 illustrates the daily notification in the last part of a periodic business cycle. For example, in the last two weeks of a business quarter, it would be desirable to carefully track last minute changes that may affect the quarterly report.

As shown in step 11 of FIG. 3, when a sales rep makes changes to events, such as a change in category, a change in the dollar amount of cost or revenue, or an expected date, the system creates a new event record and stores it in the database.

At step 12, the system examines the new event to determine if it creates an exception to the original plan. If so, the system generates an exception notification that is transmitted to management alerting them to the situation. The exception notification has detailed information concerning the change. The notification can contain information such as when a particular action item is moved from commit to not commit, when the dollar amount has changed more than a preselected percentage, and when action items have moved from the current quarter to the next quarter. All of these changes may impact the impending quarterly report, and therefore management test and interest and carefully monitoring last minute activity of this nature. Of course, every organization will have particular types of events that may be peculiar to that particular organization. Therefore, what is considered important as an exception notification will vary to suit the particular organization in question. In addition, the exception notification can be transmitted to management using any convenient technology, such as written reports, emails, text messages, SMS messages, etc.

When the appropriate management personnel receive the notification exception from the system, at step 13, a determination by management is made as to whether the notification is an informational notification, a warning notification, or an exception notification that requires corrective action. At step 14, management will make that determination and inform the sales rep and/or sales leaders as to what action may need to be taken. As a result, the dynamically operated information system provided by the invention allows management to carefully monitor last-minute changes to schedules that may impact quarterly reports, and therefore, stock prices and financial reports.

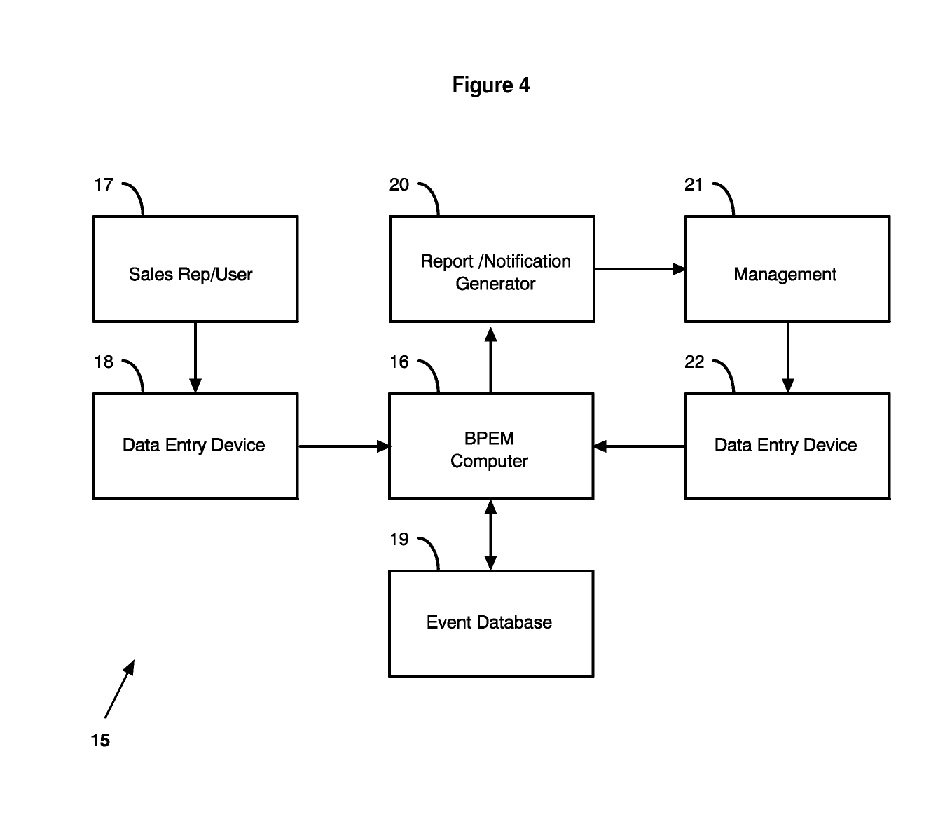

FIG. 4 is a block diagram of BPEM system 15. The sales reps 17 enter event data via data entry device 18 that is received by the BPEM computer 16. In turn, the BPEM computer 16 stores the event data entered by the sales rep 17 into the event database 19. The BPEM computer 16 analyzes events in the event database 19, and when appropriate, generates reports and/or notifications 20 that are transmitted to management 21. The reports and/or notifications 20 can take any suitable form, such as printouts, Electronic files, e-mail, text messages, SMS messages, etc. Management 21 can request reports via data entry device 22, and/or enter event data via entry device 22. The BPEM system 15 allows changes in status entered by sales reps 17 to be reported to management on a real-time basis, or on a periodic basis at the discretion of management.

The BPEM system provides a dynamically updated database system that provides management with real time status of processes that the manager is responsible for. This allows management to quickly respond to any discrepancies or problems to keep multiple projects moving forward on a time basis. Further, it allows management tomorrow to individual employee performance so that any issues related to an individual employee can be addressed at the earliest possible date.

While that previous discussion has used the sales organization to describe the BPEM database system, those skilled in the article recognize that the invention can be used for any organizational purpose. For example, in the case of an engineering development project, multiple individual tasks and engineers can be simultaneously tracked by management. In engineering development it is very important that all work items (events) it kept on time as a delay in one work item can potentially bring the entire development process to a halt until that item is completed. The dynamic nature of the invention allows management to be made aware of issues at the earliest possible time so that any necessary action can be taken. Likewise, complex organizations such as hospitals or the military rely on multiple departments to work in concert with one another to achieve expected goals. In either of these cases, not only are financial and timing interests involved, but there may also be adverse applications for patients or troops whose lives may be in danger.

Data entry of events into the database can be accomplished by any number of convenient methods, depending on the nature of the organization. For example, in a financial organization, such as a sales organization, a stock brokerage, an insurance company, etc., the data entry device would typically be the data terminal, personal computer, or similar device that allows data to be entered in a conventional manner. However, some organizations may have workers, both individual workers and/or management that did not enjoy the convenience of a fixed work location and/or terminal. In this case, the data entry device may be a portable computer, tablet, Smart phone, etc., which allows the individual to enter data from any location using any convenient communications technology, such as wireless Internet access, smart phone access, etc.

The computer used by the system controls the event database. The computer program used to analyze the event data has preselected criteria related to the unique applications used by given organization type. Management determines what criteria are necessary to achieve the goals of the organization, and the computer program dynamically monitors changes to the event database to notify management of status changes.

While specific embodiments have been discussed to illustrate the invention, it will be understood by those skilled in the art that variations in the embodiments can be made without departing from the spirit of the invention. The types of underlying activities can vary while using the methods implemented by the invention, the activities can relate to general business, construction, research, engineering development, sales, manufacturing, etc. Likewise, it can be used by government organizations, private for-profit organizations, non-profit organizations, etc. Therefore, the invention shall be limited solely to the scope of the claims.

I Claim:

1. A method for interactively monitoring, reporting, and modifying complex events, including the steps of:
using a computer to create an event database;
using one or more data entry devices for entering event data into the event database, the events in the event database each related to an action or result, or an expected action or result; and
using a computer program to dynamically monitor changes to the event database, comparing changes to events against previously expected event status, and automatically generating notifications when changes exceed preselected criteria;
whereby management is automatically notified when changes to events may impact organizational performance and/or schedules.

2. A method, as in claim 1, including the additional step of:
using the data entry devices to access the event database by individuals performing work tasks, by group leaders managing efforts by individuals, and by senior management.

3. A method, as in claim 2, including the additional step of:
using the events in the events database to represent steps in a sales or marketing process, a construction process, and/or an engineering or research process.

4. A method, as in claim 2, including the additional steps of:
including a description of the event, the expected event results, and the projected date of completion in newly created events; and
outputting the newly created event to the event database.

5. A method, as in claim 4, including the additional step of:
analyzing the events in the event database to identify any events that have diverged from expected event criteria by a predetermined amount, and generates alerts/notifications for those events.

6. A method, as in claim 5, including the additional step of:
categorizing the alerts/notifications as informational, warning, or exception, where informational notifications describe normal event changes, warning notifications describe unexpected event changes, and exception notifications require action.

7. A method, as in claim 6, including the additional step of:
generating a list of action items in response to one or more of the alerts/notifications for a selected time period.

8. A method, as in claim 7, including the additional steps of:
generating a list of event changes associated with outstanding action items.

9. A system for interactively monitoring, reporting, and modifying complex events, comprising:
a computer having an event database;
a plurality of data entry devices for entering events into the event database, the events in the event database each related to an action or result, or an expected action or result; and
a computer program to dynamically monitor changes to the event database, and automatically generating notifications when changes to events exceed predetermined criteria;
whereby management is automatically notified when changes to events may impact organizational performance and/or schedules.

10. A system, as in claim 9, wherein:
at least one of the data entry devices are mobile devices.

11. A system, as in claim 10, wherein:
at least one of the mobile devices is a cellular telephone, a smart phone, a tablet computer, or a portable computer.

12. A system, as in claim 9, wherein:
the notifications are categorized as to the nature of the action to be taken in response to the notification.

13. A system, as in claim 12, wherein:
at least some of the notifications are categorized as requiring immediate action.

14. A system for interactively monitoring, reporting, and modifying complex events, comprising:
a computer;
an event database operatively connected to the computer;
at least a first data entry device for entering events into the event database;
a report/notification generator that automatically generates alert/notifications when changes to events exceed predetermined criteria;
at least a second data entry device for querying the event database by management, and/or entering management instructions in response to alerts/notifications;
whereby management is dynamically notified when changes to events may impact organizational performance and/or schedules.

15. A system, as in claim 14, wherein:
the report/notification generator categorizes the alerts/notifications as informational, warning, or exception, where informational notifications describe normal event changes, warning notifications describe unexpected event changes, and exception notifications require action.

16. A system, as in claim 15, wherein:
the report/notification generator generates a list of action items in response to one or more of the alerts/notifications for a selected time period.

17. A system, as in claim 16, wherein:
the report/notification generator generates a list of event changes associated with outstanding action items.

18. A system, as in claim 17, wherein:
the report/notification generator generates reports that associate events and action items with responsible individuals.

19. A system, as in claim 14, wherein:
at least one of the first or second data entry devices is a mobile device; and
at least one of the mobile devices is a cellular telephone, a smart phone, a tablet computer, or a portable computer.

20. A system, as in claim 14, wherein:
the events in the events database represents steps in a sales or marketing process, a construction process, and/or an engineering or research process.
